(19) United States
(12) Patent Application Publication
(10) Pub. No.: US 2008/0001338 A1
(43) Pub. Date: Jan. 3, 2008

(54) Sheet folding apparatus and sheet processing apparatus

(75) Inventor: Takashi Kotani, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/821,802

(22) Filed: Jun. 26, 2007

(30) Foreign Application Priority Data
Jun. 30, 2006 (JP) 2006-180966

(51) Int. Cl. B41L 43/12; B65H 45/00

(52) U.S. Cl. 270/37; 493/444

(57) ABSTRACT

A sheet folding apparatus for folding a bundle of sheets at its center includes a pair of center-folding rollers including a first roller and a second roller. Each roller is rotatable about an axis thereof. The first roller and the second roller are pressed in contact with each other to define a nipping portion, but are separable from each other. A center-folding blade projects towards the nipping portion for pushing a folding portion of the bundle of sheets into the nipping portion. The pair of center-folding rollers nips and conveys the folding portion to fold the bundle of sheets into a two-fold. A pivotal shaft is provided for swingably supporting the center-folding blade. A projecting leading end of the center-folding blade is swung in accordance with the thickness of the bundle of sheets that is to be folded at its center.

### BACKGROUND OF THE INVENTION

1. Field of the Invention. The present invention relates to a sheet folding apparatus for folding a bundle of sheets into two-fold, and a sheet processing apparatus adopting the same.

2. Description of the Related Art. There has been a known sheet folding apparatus in which a bundle of sheets (a bundle of plurality of sheets) is stapled or center-stapled at its substantially central portion with a staple, and the bundle of sheets is folded into two-fold at the stapled portion.

In FIG. 9, one example of such sheet folding apparatus is shown. The sheet folding apparatus includes a folding roller pair 100 including a driving folding roller 101 and a driven folding roller 102 being made in pressed contact with each other to define a nipping portion N. Further, a holder 103 holds a center-folding blade 104, and first guide rollers 105 and second guide rollers 106 are rotatably retained by the holder 103.

The first guide rollers 105 and the second guide rollers 106 are movably fitted in a guide groove 107 extending in a tangential direction through the nipping portion N. When the holder 103 is moved by an unillustrated driving mechanism toward the folding roller pair 100, the first guide rollers 105 and the second guide rollers 106 are moved along the guide groove 107. Then, the center-folding blade 104 held by the holder 103 is moved toward the nipping portion N. Accordingly, the center-folding blade 104 pushes a folding portion of the bundle of sheets into the nipping portion N, and the pair of center-folding rollers 100 nips and conveys the bundle of sheets, thereby folding the bundle of sheets into two-fold.

The above-described first guide rollers 105 and second guide rollers 106 have diameters D1, D2 respectively. The diameters D1, D2 are set to be about 1 mm smaller than a groove width W which is a distance between first and second guide surfaces 108, 109 of the guide groove 107. In other words, the first guide rollers 105 and second guide rollers 106 are movably fitted with clearances W1, W2 of about 1 mm with respect to the groove width W of the guide groove 107. Such configuration allows the sheet folding apparatus to deal with various thicknesses of bundle of sheets.

According to the above-described configuration, the sheet folding apparatus can deal with a change in the thickness of the bundle of sheets to some extent. However, especially when a bundle of sheets has a great thickness, there have been some cases where a deviation of a folding position, wrinkles, abrasion or the like occur. A reason why such problem occurs is because clearances W1, W2 provided for both of the first guide rollers 105 and the second guide rollers 106 make it difficult to stabilize the postures of the center-folding blade 104 and the holder 103 when a bundle of sheets is pushed into the nipping portion N with the center-folding blade 104.

For example, as shown in FIG. 9, the holder 103 is likely to swing in accordance with a deviation of the second guide rollers 106 while making the guide roller 105 come in contact with the first guide surface 108, and a deviation of the second guide rollers 106 while making the first guide roller 105 come in contact with the second guide surface 109. Further, the holder 103 is likely to swing in accordance with a deviation of the first guide roller 105 while making the guide roller 106 come in contact with the first guide surface 108, and a deviation of the first guide roller 105 while making the second guide roller 106 come in contact with the other guide surface 109. In accordance with the deviations described above, the holder 103 is likely to have various postures. However, such variety of postures causes the holder 103 to be unstable.

A sheet folding apparatus which is so configured as to solve such problem is disclosed, for example, in Japanese Patent Unexamined Publication No. HEI 10-167562. The sheet folding apparatus is so configured as to prevent a bundle of sheets from a deviation of a folding position, wrinkles, breakage and the like which are caused by deviation of a moving axis direction of a projecting plate or center-folding blade and a tangential direction of a folding roller pair. Specifically, there is provided on the projecting plate a projecting side contact portion which is moved integrally with the projecting plate. On the other hand, there is provided on the side of the folding rollers a cam for guiding the projecting plate to a nipping portion between the folding rollers. Accordingly, the moving axis direction of the projecting plate and the tangential direction of the folding roller are aligned with each other, thereby eliminating the above-described problem.

However, in the above-described conventional art, a radius R1 of each folding roller, a radius R2 of the cam, a thickness t of the projecting side contact portion and the like are set such that the moving axis direction of the projecting plate and the tangential direction of the folding rollers are aligned when there is no bundle of sheets. Therefore, there has been a problem that it works appropriately when the bundle of sheets has a small thickness but does not necessarily work sufficiently when the bundle of sheets has a great thickness.

Specifically, when a bundle of sheets has a great thickness, the projecting plate being guided by the projecting side contact portion to move along the tangential direction of the folding rollers until just before a folding portion of the bundle of sheets is nipped at the nipping portion between the folding rollers. However, the projecting plate is deviated a distance corresponding to the thickness of the bundle of sheets just after being nipped. In other words, there is the likelihood that a deviation in a folding position, wrinkles, breakage and the like occur in a bundle of sheets when the bundle of sheets has a great thickness.

### SUMMARY OF THE INVENTION

An object of the present invention is to provide a sheet folding apparatus in which occurrence of a deviation in a folding position, wrinkles, breakage and the like in the bundle of sheets is suppressed even when the thickness of a bundle of sheets is changed or becomes thicker, and a sheet processing apparatus adopting the same.

A sheet folding apparatus according to one aspect of the present invention which accomplishes the object is a sheet folding apparatus for folding a bundle of sheets at its center. The sheet folding apparatus comprises: a pair of center-folding rollers including a first roller and a second roller, each roller being rotatable about an axis thereof, the first roller and the second roller being made pressed contact with each other to define a nipping portion but being separable from each other; a center-folding blade projecting toward the nipping portion for pushing a folding portion of the bundle of sheets into the nipping portion so as to allow the pair of center-folding rollers to nip and convey the folding portion to thereby fold the bundle of sheets into two-fold; a holder for holding a base end portion of the center-folding blade; a guide member including a guide groove having a pair of guide surfaces extending along a tangential direction through the nipping portion; a first guide roller and a second guide roller held by the holder and rollable in the guide groove, the first guide roller being arranged closer to the nipping portion than the second guide roller; and a driving mechanism for moving the center-folding blade to the nipping portion via the holder. A first clearance between a groove width of the guide groove and a diameter of the first guide roller is a first necessity minimum length to allow the first guide roller to roll in the guide groove, and a second clearance between the groove width and a diameter of the second guide roller is a second length longer than the first necessity minimum length.

Further, a sheet processing apparatus according to another aspect of the present invention comprises: a sheet folding apparatus for performing a center-folding processing to a bundle of sheets; a sheet-receiving portion for receiving supply of the sheet; a sheet-discharging portion for discharging a processed sheet; and a conveyance path for allowing the sheet supplied from the sheet-receiving portion to be conveyed to the sheet-discharging portion via the sheet folding apparatus. The sheet folding apparatus includes: a pair of center-folding rollers including a first roller and a second roller, each roller being rotatable about an axis thereof, the first roller and the second roller being made pressed contact with each other to define a nipping portion but being separable from each other; a center-folding blade projecting toward the nipping portion for pushing a folding portion of the bundle of sheets into the nipping portion so as to allow the pair of center-folding rollers to nip and convey the folding portion to thereby fold the bundle of sheets into two-fold; and a pivotal shaft for swingably supporting the center-folding blade so as to allow a projecting leading end of the center-folding blade to be swung in accordance with a thickness of a bundle of sheets to be folded at its center.

These and other objects, features, and advantages of the present invention will become more apparent upon reading of the following detailed description along with the accompanied drawings.

### BRIEF DESCRIPTION OF THE DRAWINGS

FIG. 1 is a front sectional view schematically showing a whole configuration of a sheet processing apparatus according to one embodiment of the present invention.

FIG. 2 is an enlarged view showing a stapling apparatus of FIG. 1.

FIG. 3 is an enlarged view showing a sheet folding apparatus of FIG. 1.

FIG. 4 is a vertical sectional view showing a cross section of the sheet folding apparatus taken along a plane perpendicular to the forward and rearward directions. The sheet folding apparatus is in a state where a blade unit is at the uppermost part.

FIG. 5 is a perspective view of the blade unit which is viewed substantially from front.

FIG. 6 is a perspective view showing the blade unit and a driving mechanism driving the same, which are viewed from oblique upper right front.

FIG. 7 is a schematic diagram showing an operation of the blade unit.

FIG. 8 is a vertical sectional view showing a modification of the sheet folding apparatus.

FIG. 9 is a schematic diagram showing an operation of a conventional sheet folding apparatus.

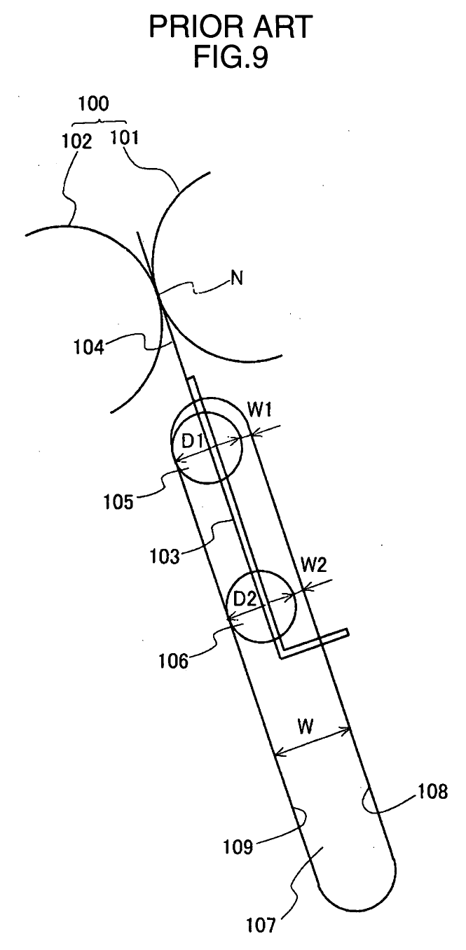

### DETAILED DESCRIPTION OF THE PREFERRED EMBODIMENTS

Hereinafter, a preferred embodiment of the present invention will be described in detail with reference to the drawings. In the drawings, the members and the like provided with the same reference signs have the same function. Therefore, duplicated descriptions of these members and the like will be abbreviated appropriately. Further, members and the like which are not necessary to be described are appropriately omitted.

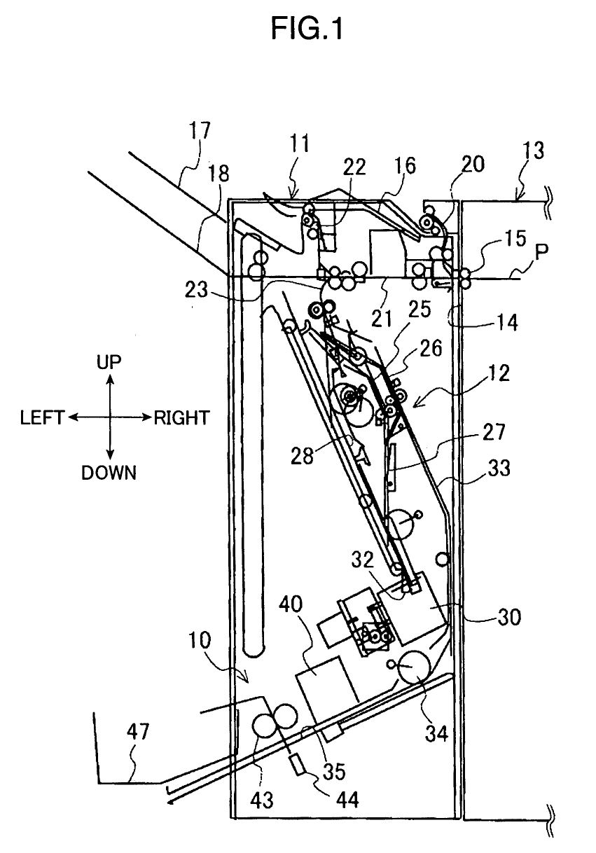

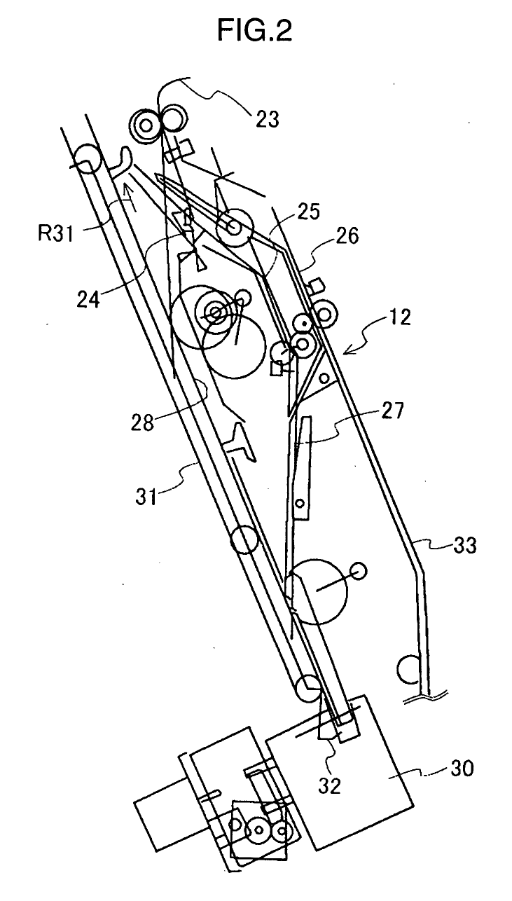

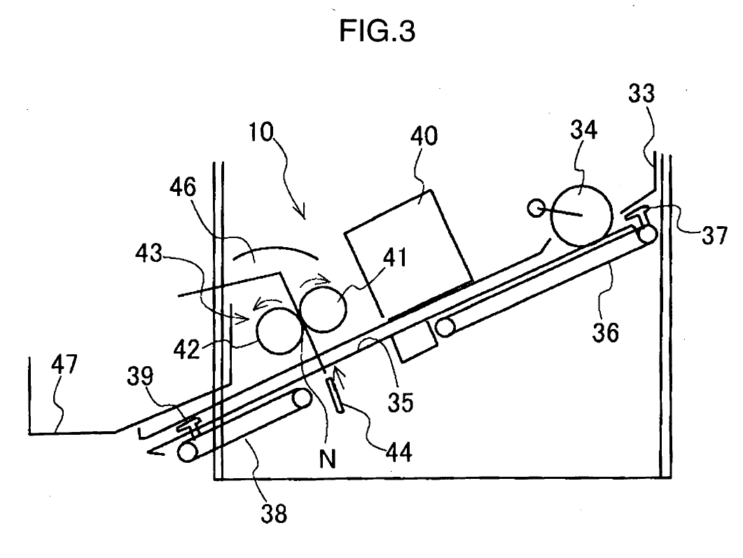

At first, a sheet processing apparatus 11 provided with a sheet folding apparatus 10 according to one aspect of the present invention will be schematically described with reference to FIGS. 1 to 3. FIG. 1 is a front sectional view schematically showing a whole configuration of the sheet processing apparatus 11 according to an embodiment of the present invention. Hereinafter, directions of arrows shown on the left hand portion in FIG. 1 are determined as actual vertical and horizontal directions in an actual machine such as a sheet folding apparatus 10 and a sheet processing apparatus 11, and directions perpendicular to those are determined as forward and rearward directions. The forward and rearward directions as determined above correspond to a sheet width direction, which is a direction perpendicular to a conveyance direction, of a sheet P as a recording medium. For example, the sheet P includes a normal copy sheet, a processed sheet such as a coat sheet, and a transparent film. FIG. 2 is an enlarged view showing a stapling apparatus 12 shown in FIG. 1. FIG. 3 is an enlarged view showing the sheet folding apparatus 10 shown in FIG. 1.

As shown in FIG. 1, the sheet processing apparatus 11 is arranged so as to be adjacent to a left side surface 14 of an image forming apparatus 13 such as a copier and a printer. Here, as an image forming method of the image forming apparatus 13, a method such as an electrophotographic method, an electrostatic recording method and an ink-jet method may be adopted.

A sheet P on which an image is formed in the image forming apparatus 13 is discharged leftward from the image forming apparatus by the sheet-discharging roller 15 arranged near a sheet discharging opening formed in the left side surface 14 of the image forming apparatus 13. The discharged sheet P passes through an opening or sheet-receiving portion facing the sheet-discharging rollers 15 and is supplied to an inner portion of the sheet processing apparatus 11.

As shown in FIG. 1, the sheet processing apparatus 11 is provided with sheet-discharging trays (sheet-discharging portions) 16, 17, 18, a stapling apparatus 12, the sheet folding apparatus 10, conveyance paths 20-27, 33 for conveying the sheet P between these elements, and the like. These elements are used in accordance with the cases of (1) not performing a processing, (2) performing a stapling processing and (3) performing a center-folding processing to a sheet P on which an image is formed.

(1) In the case where a processing is not performed to a sheet P on which the image is formed, the sheet P on which an image is formed is discharged to the sheet-discharging tray 16 via the conveyance path 20 extending upward in a vicinity of the sheet-discharging roller 15. Alternatively, the sheet P is discharged to the sheet-discharging tray 17 via the conveyance path 21 extending leftward and the conveyance path 22 extending upward from a halfway of the conveyance path 21. Yet alternatively, the sheet P is discharged to the sheet discharging tray 18 from the left end or the downstream end of the conveyance path 21. The sheet-discharging tray 18 can be lifted up and down, and a large amount of sheet P can be stacked thereon when the sheet-discharging tray 18 is lifted down.

(2) In the case where a stapling processing is performed, a sheet P on which an image is formed is successively discharged via the conveyance path 21, the conveyance path 23 extending downward from the halfway of the conveyance path 21, and the conveyance paths 24, 25, 26, 27 and the like shown in FIG. 2, and stacked on the intermediate tray 28. The sheets P are aligned in a conveyance direction and width direction to form a bundle of sheets (a bundle of plurality of sheets P). Thereafter, one corner or two corners of a leading end of the bundle of sheets P is stapled in a flat state by a first stapler 30 with a staple. After the bundle of sheets is stapled, a hook 32 which is disposed to a bundle-discharging belt 31 is moved in accordance with a rotation of the bundle discharging belt 31 in a direction of an arrow 31, thereby pushing out the bundle of sheets and discharging the same to the sheet-discharging tray 18.

(3) In the case where a center-folding processing is performed to a sheet, the sheet P on which an image is formed is supplied to the sheet folding apparatus 10 via the conveyance paths 21, 23, 26, 33 shown in FIG. 1. The sheet P conveyed through the conveyance path 33 is discharged to the holding tray 35 by the sheet-discharging roller 34 as shown in FIG. 3, and successively aligned in the conveyance direction and the sheet width direction.

On the upstream from the holding tray 35, an aligning belt 36 is provided which is rotatable in forward and reverse directions. The aligning belt 36 is provided with a bundle lowering member 37 being disposed so as to be projected from an upper surface of the holding tray 35. On the other hand, on the downstream from the holding tray 35, there is provided an aligning belt 38 which is rotatable in forward and reverse directions. The aligning belt 38 is provided with a bundle lifting member 39 being attached so as to be projected from the upper surface of the holding tray 35.

These aligning belts 36, 38 are appropriately rotated in forward and reverse directions in accordance with a timing of a sheet P discharged to the holding tray 35 by the sheet-discharging roller 34. Accordingly, the sheets P on the holding tray 35 are aligned with respect to the conveyance direction by the bundle lowering member 37 and the bundle lifting member 39. On the other hand, with respect to the sheet width direction, the aligning is performed by a left side restricting plate and a right side restricting plate (unillustrated) which come in contact with a left end and a right end of the sheets P placed on the holding tray 35 to position the sheets P.

In such a manner as described above, the bundle of sheets aligned with respect to the conveyance direction and the sheet width direction is stapled by the second stapler 40 with a staple at its folding portion (or a portion to be folded into two-fold later) located in a substantially central position in the conveyance direction. After the center-stapling, the bundle of sheets is folded at its center by a pair of center-folding rollers 43 including center-folding rollers 41, 42, and a blade unit 44.

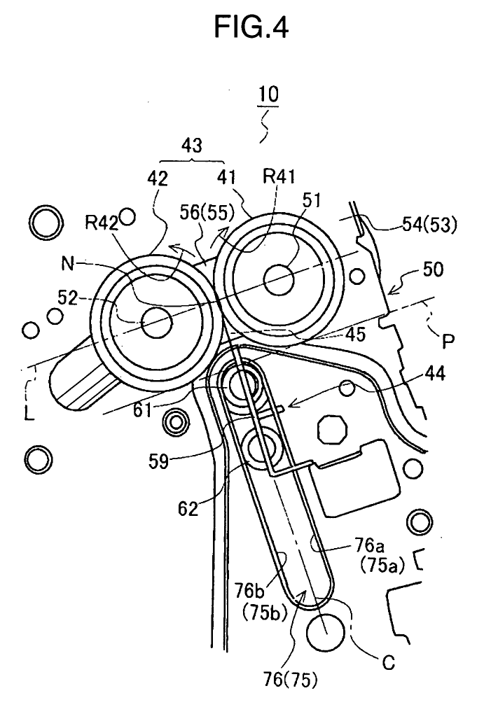

Specifically, after the center-stapling is performed, a folding portion (a stapling portion) of the bundle of sheets is moved by the aligning belts 36, 38 to a position corresponding to the nipping portion N of the pair of center-folding rollers 43 and the blade unit 44. Then, the bundle of sheets is pushed into the nipping portion N at its folding portion by a center-folding blade 45 (refer to FIG. 4) of the blade unit 44, and nipped and conveyed in accordance with a rotation in a direction of arrow of the pair of center-folding rollers 43. Accordingly, the bundle of sheets is folded into two-fold. After being folded, the bundle of sheets is further conveyed by the pair of center-folding rollers 43 along a discharging guide 46 and discharged to the sheet-discharging tray 47.

As described above, the sheet processing apparatus 11 directly discharges the sheet P being formed with an image to the sheet-discharging trays 16, 17, 18, discharges the bundle of sheets to the sheet-discharging tray 18 after the flat stapling, or discharges the bundle of sheets to the sheet-discharging tray 47 after the center-stapling and center-folding.

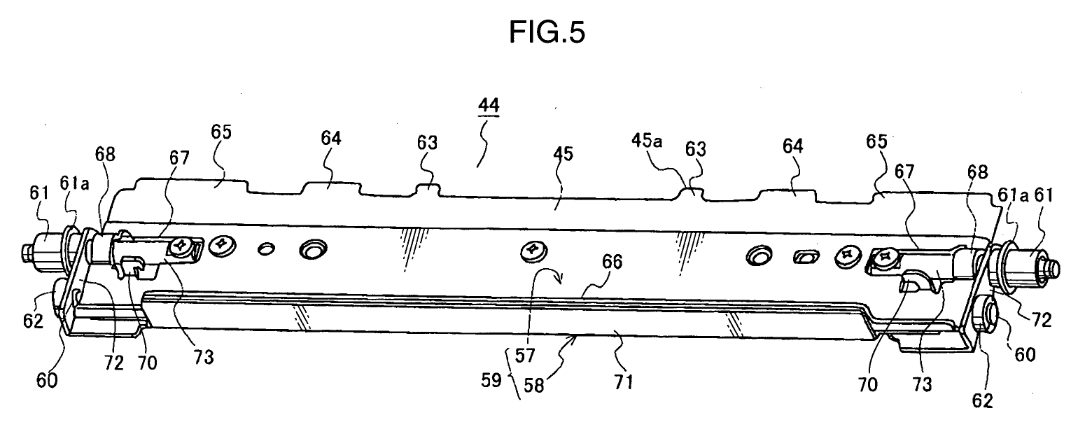

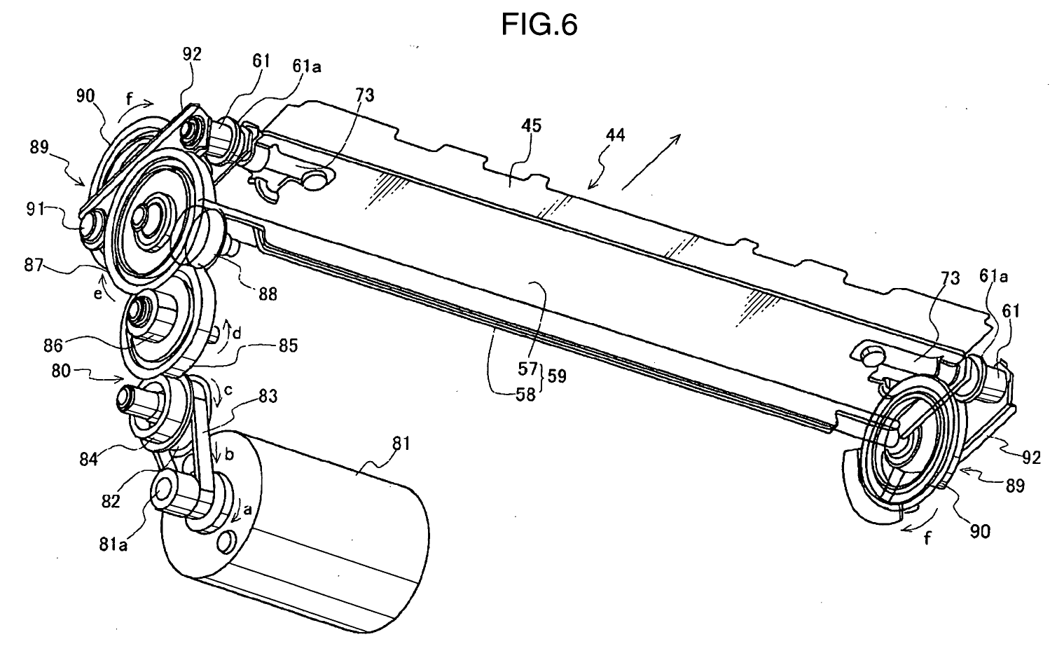

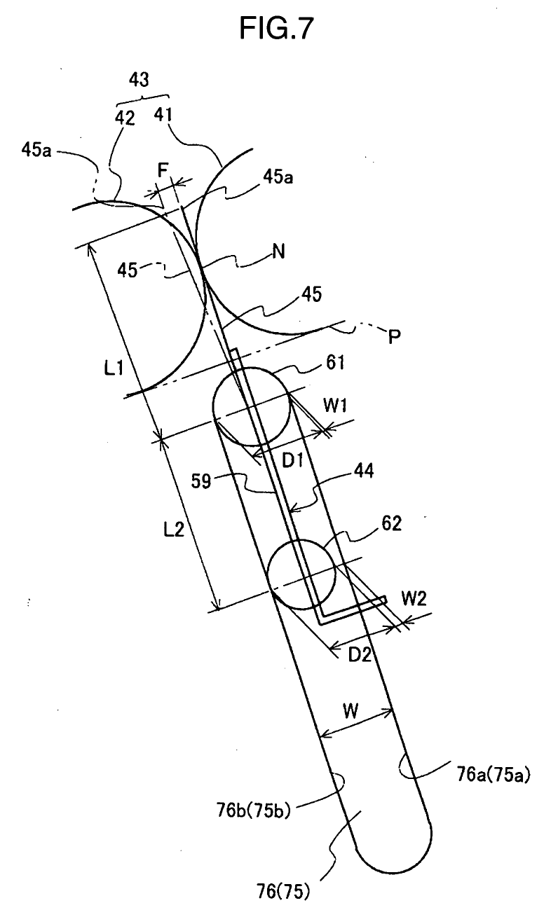

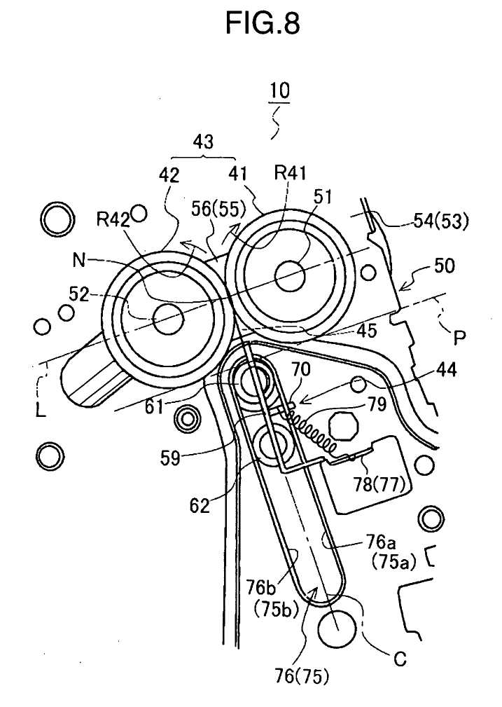

Next, the sheet folding apparatus 10 according to the present embodiment will be described in detail with reference to FIGS. 4 to 8. FIG. 4 is a vertical sectional view showing a cross section of the sheet folding apparatus 10 taken along a plane perpendicular to the forward and rearward directions and showing the state where the blade unit 44 is positioned at the uppermost portion. FIG. 5 is a perspective view of the blade unit 44 which is viewed substantially from front. The left side in FIG. 5 corresponds to the front side of an actual machine, and the right side in FIG. 5 corresponds to the rear side of the actual machine. Further, FIG. 6 is a perspective view showing the blade unit 44 and a driving mechanism 80 driving the same, which are viewed from an oblique upper right front side. FIG. 7 is a view showing an operation of the blade unit 44. FIG. 8 is a vertical sectional view showing a modified sheet folding apparatus.

As shown in FIGS. 3 and 4, the sheet folding apparatus 10 is provided with the pair of center-folding rollers 43 and the blade unit 44.

The pair of center-folding rollers 43 includes center-folding rollers 41, 42 each having substantially the same shape. The center-folding roller 41 (hereinafter, referred to as “first roller 41”) is a driving center-folding roller rotated with a driving force given thereto. The center-folding roller 42 (hereinafter, referred to as “second roller 42”) is a driven center-folding roller which is made to come in pressed contact with the first roller 41 to define the nipping portion N and is rotated by the first roller 41. The second roller 42 is movable in a direction separating from the first roller 41.

A detailed configuration of the pair of center-folding rollers 43 will be described. Both the first roller 41 and the second roller 42 are elongated in forward and rearward directions, and respective rotational shafts 51, 52 are rotatably supported at bearings (unillustrated) provided in a front frame 53 and a rear frame 54 of a main body frame 50. The rear frame 54 is shown in FIG. 4. However, the front frame 53 has substantially the same configuration as that of the rear frame 54.

Here, the bearings supporting the rotational shaft 51 of the first roller 41 are fixedly provided on the front frame 53 and the rear frame 54. On the contrary, the bearings supporting the rotational shaft 52 of the second roller 42 are movably supported at guide grooves 55, 56 formed respectively in the front frame 53 and the rear frame 54. In the present embodiment, orientations of the guide grooves 55, 56 i.e. orientations of lines L through rotational shafts 51, 52 of the first and rollers 41, 42 are tilted such that the left portions of the guide grooves 55, 56 are positioned lower. This tilting direction is aligned with the tilting direction of the holding tray 35 shown in FIG. 3.

The second roller 42 is moved along the above-described guide grooves 55, 56 so that it comes in contact with the first roller 41 or separates therefrom. The second roller 42 is urged by a biasing member (unillustrated) to come in pressed contact with the first roller 41. Accordingly, the nipping portion N is defined between the first roller 41 and the second roller 42. The first roller 41 is rotated by a driving mechanism in a direction of an arrow R41. In accordance with this, the second roller 42 is drivenly rotated in a direction of an arrow R42. The pair of center-folding rollers 43 including the first and second rollers 41, 42 nip and convey a bundle of sheets which is pushed into the nipping portion N with the blade unit 44 described herebelow, thereby folding the bundle of sheets into two-fold.

Next, as shown in FIGS. 4 to 6, the blade unit 44 includes a plate-like center-folding blade 45, a holder 59 for holding a base end of the center-folding blade 45, and first guide rollers 61, 61 and second guide rollers 62, 62 provided at front and rear opposite end portions of the holder 59.

As shown in FIG. 5, the center-folding blade 45 composed of a plate-like member having a substantially rectangular shape which is elongated in forward and rearward directions. For example, the center-folding blade 45 may be composed of a steel plate having a thickness of 0.3 mm and a desirable elasticity. At a leading end 45a of the center-folding blade 45, there are formed salient portions 63, 63, 64, 64, 65, 65. These salient portions 63, 63, 64, 64, 65, 65 are provided symmetrically in forward and rearward directions with a reference point at a center in forward and rearward directions.

These salient portions 63, 63, 64, 64, 65, 65 are provided at positions corresponding to a sheet width of a sheet P of a kind which is frequently used. Specifically, the center-folding blade 45 pushes a folding portion of a bundle of sheets with its leading end 45a into the nipping portion N of the above-described pair of center-folding rollers 43 by pushing a vicinity of opposite ends in the sheet width direction of the bundle of sheets with these salient portions 63, 63, 64, 64, 65, 65. Accordingly, the bundle of sheets can be folded into two-fold favorably, and the center-folding blade 45 can be easily pulled out of the bundle of sheets which are folded in two-fold and nipped and conveyed at the nipping portion N. The center-folding blade 45 is supported at its base end by a plate-like holder 59.

The holder 59 includes a pair of holding plates i.e. a right holding plate 57 and a left holding plate 58. The right holding plate 57 and the left holding plate 58 are formed to have the same length as that of the above-described center-folding blade 45. The right holding plate 57 and the left holding plate 58 presses the base end of the center-folding blade 45 and are fastened with screws to hold the center-folding blade 45.

The right holding plate 57 has at its lower end a bent portion 66 oriented rightward. Further, the right holding plate 57 has notches 67, 67 at its front end and rear end, and pressing portions 68, 68 for pressing shafts 73, 73. At the notches 67, 67, there are placed shafts 73, 73 described hereinafter. Further, in vicinities of notches 67, 67, there are provided hooks 70, 70. In the case where pull springs 79 (refer to FIG. 8) are used as biasing members, one end of each pull spring 79 is latched to a hook 70.

On the other hand, the left holding plate 58 has at its lower end portion a bent portion 71 which overlays on the bent portion 66 of the above-described right holding plate 57, and has at its front end and rear end bent portions 72, 72 which are bent rightward. The shafts 73, 73 serving as a pivotal axis of the holder 59 penetrates through these bent portions 72, 72 in forward and rearward directions, and base ends of the shafts 73, 73 are located at the notches 67, 67 and fastened with screws to the left holding plate 58. Further, an intermediate portion of the shafts 73, 73 are pressed between pressing portions 68, 68 and the left holding plate 58. The first guide rollers 61, 61 are rotatably supported at respective extremity ends of the shafts 73, 73 which penetrate through the bent portions 72, 72 and projected outward.

The first guide rollers 61, 61 and the second guide rollers 62, 62 are formed to be cylindrical. The first guide rollers 61, 61 have flange-like stoppers 61a, 61a at positions close to base ends of the shafts 73, 73. The second guide rollers 62, 62 are rotatably supported by shafts 60, 60. The shafts are provided on the lower side from the first guide rollers 61, 61 in the bent portion 72 and projected outward from the bent portion 72. The guide rollers 62, 62 and the inner portions of the first guide rollers 61, 61 than the stoppers 61a, 61a are engaged with guide grooves 75, 76 which will be described hereinafter.

As shown in FIG. 4, the guide grooves 75, 76 extending toward the nipping portion N are formed in the front frame 53 and the rear frame 54 (guide members) at portions near the pair of center-folding rollers 43. The guide groove 75 has a pair of guide surfaces 75a, 75b separated a groove width W and facing each other. Similarly, the guide groove 76 has a pair of guide surfaces 76a, 76b separated a groove width W and facing each other. The guide surfaces 75a, 75b and the guide surfaces 76a, 76b are pairs of guide surfaces provided along a tangential direction of the nipping portion N.

The guide grooves 75, 76 are formed such that an extension of a center C of the groove width W is aligned with the nipping portion N of the above-described pair of center-folding rollers 43. In other words, a center line C is oriented in a direction substantially perpendicular to the above-described straight line L. Further, the above-described straight line L is tilted such that the line lowers leftward as described above. Thus, the guide grooves 75, 76 are tilted such that the guide grooves 75, 76 rise leftward. The above-described first guide rollers 61, 61 and the second guide rollers 62, 62 are fitted in the guide grooves 75, 76 with an appropriate clearance as described below.

As shown in FIG. 7, the first guide roller 61 has a diameter D1, and a difference between the diameter D1 and the groove width W is a first clearance W1 (=W−D1). Similarly, the second guide roller 62 has a diameter D2, and a difference between the diameter D2 and the groove width W is a second clearance W2 (=W−D2). In the present embodiment, the first clearance W1 is set to be a possible minimum value. Here, “minimum” means that the first guide rollers 61, 61 have a necessity minimum length (first length) to smoothly roll or move in the guide grooves 75, 76. In principle, the clearance W1 may have a value which is extremely close to 0.

On the other hand, the second clearance W2 has a length (second length) greater than the first clearance W1. Here, “greater” means that the second clearance W2 has a length greater than the clearance which allows the second guide roller 62, 62 to roll smoothly. In other words, a play is positively provided. Accordingly, the second guide rollers 62, 62 can be moved or deviated within the groove width W of the guide grooves 75, 76.

Since the first and second clearances W1, W2 are provided as described above, the blade unit 44 (the holder 59, and the center-folding blade 45 held by the holder 59) can swing about the first guide rollers 61, 61 as a center (swing about the first guide rollers 61, 61 as a pivotal supporting point). Accordingly, the leading end 45a of the center-folding blade 45 can be moved or swung.

In the present embodiment, the blade unit 44 is pushed in a substantially oblique upper right direction by a link 92 of a crank mechanism 89 which are described below. Further, the guide grooves 75, 76 are tilted leftward as described above. Therefore, the second guide rollers 62, 62 comes in contact with guide surfaces 75b, 76b on the left side (the guide surfaces positioned on the side of the driven center-folding roller 42) in the guide grooves 75, 76 under the own weight of the blade unit 44.

Assuming that the guide surfaces 75b, 76b are reference guide surfaces, a state where the second guide rollers 62, 62 comes in contact with the reference guide surfaces is a reference posture of the blade unit 44 including the holder 59 and the center-folding blade 45. When the blade unit 44 is driven by the driving mechanism 80 in a state where there is no bundle of sheets, it is raised along the guide grooves 75, 76 while keeping the reference posture, and the leading end 45a of the center-folding blade 45 pushed into the nipping portion N. In other words, the reference posture is set so as to allow the above-described operation to be performed.

As described above, the blade unit 44 comes into the reference posture under its own weight. Therefore, when a folding portion of a bundle of sheets is pushed up into the nipping portion N of the pair of center-folding rollers 43 by the center-folding blade 45 of the blade unit 44, the blade unit 44 can be moved against a force given from the bundle of sheets to the blade unit 44.

In some cases, the reference posture of the blade unit 44 cannot be maintained assuredly under its own weight in accordance with an orientation of the guide groove 75, 76. In such cases, spring members may be provided between the front frame 53 and a part of a front end of the holder 59, or between the rear frame 54 and a part of a rear end of the holder 59 respectively. Thus, the spring members urge the blade unit 44 to keep at the reference posture.

FIG. 8 shows a modified embodiment where a pair of springs 79 are provided as spring members. The springs 79 are latched at their first ends to the above-described hooks 70, 70 respectively, and at their second ends to latching portions 78, 79 provided respectively in the front frame 53 and the rear frame 54. By a biasing force given by the springs 79, the reference posture of the blade unit 44 is maintained.

As shown in FIG. 6, the blade unit 44 is driven by the driving mechanism 80. FIG. 6 shows a connection between the blade unit 44 and the driving mechanism 80, and other members are appropriately omitted from the drawing. The driving mechanism 80 includes a motor 81.

A torque of the motor 81 is transmitted to a gear 84 integrally formed with a pulley 82 via a driving belt 83 extending between an output shaft 81a of the motor 81 and the pulley 82. The gear 84 is in mesh with a large-diameter gear 85, and a torque of the gear 84 is transmitted via the large-diameter gear 85 at a reduced speed to a small-diameter gear 86 which is integrally formed with the large-diameter gear 85. The small-diameter gear 86 is in mesh with other large-diameter gear 87, and a torque of the small-diameter gear is transmitted via the large-diameter gear 87 at a reduced speed to other small-diameter gear 88 integrally formed with the large-diameter gear 87. A torque of the small-diameter gear 88 is transmitted to a driving gear 90 which constitutes a part of a crank mechanism 89.

The crank mechanism 89 includes a driving gear 90, a pin 91 projected outward at a position away off from a center of the driving gear 90, and a link 92 disposed between the pin 91 and a shaft 73 on the above-described blade unit 44. A similar crank mechanism 89 is provided also on the rear end of the blade unit 44 (right hand side in FIG. 6). The crank mechanism 89 on the front end and the crank mechanism 89 on the rear end are connected via a connecting shaft 93 integrally formed with respective shafts of the driving gears 90, 90. The crank mechanism 89 is at a home position when a longitudinal direction of the link 92 and a front direction of the center-folding blade 45 (direction shown in FIG. 4) agree with each other, in other words, when the pin 91 is located at the farthermost position from the shaft 73.

Each member of the driving mechanism 80 is rotated as described herebelow when the crank mechanism 89 is at the home position, and the output shaft 81a is rotated in the direction of an arrow a. In other words, in accordance with the rotation of the output shaft 81a in the direction of the arrow a, the driving belt 83 rotates in the direction of an arrow b, the pulley 82 and the gear 84 rotate in the direction of an arrow c, the large-diameter gear 85 and the small-diameter gear 86 rotate in the direction of an arrow d, and other large-diameter gear 87 and other small-diameter gear 88 then rotate in the direction of an arrow e.

Accordingly, the driving gear 90 of the crank mechanism 89 rotates in the direction of an arrow f. The link 92 pushes the shaft 73 of the blade unit 44 in a substantially upper-right direction while the driving gear 90 rotates half the way. Further, while the driving gear 90 rotates the remaining half of the way, the blade unit 44 is moved down in a substantially lower-right direction. In accordance with these operations, the blade unit 44 including the holder 59 and the center-folding blade 45 is moved up and down, in other words, the blade unit 44 is push into the nipping portion N and moved down in accordance with the rolling (movement) of the first guide rollers 61, 61 and the second guide rollers 62, 62 along the guide grooves 75, 76.

In the state where there is no bundle of sheets, this movement is performed while the blade unit 44 is maintained at the reference posture under its own weight. Further, the leading end of the center-folding blade 45 is pushed upward about 5 mm from the straight line L in FIG. 4 in a state of being positioned at the uppermost.

In the sheet folding apparatus 10 having the above-described configuration, in the state where the crank mechanism 89 is at the home position, a bundle of sheets is placed on the holding tray 35 such that a folding portion (binding portion) of the bundle of sheets corresponds to the nipping portion N between the center-folding blade 44 and the pair of center-folding rollers 43 as shown in FIG. 3. When the motor 81 is rotated thereafter, the blade unit 44 is moved up along the guide grooves 75, 76, and the center-folding blade 45 pushes up the folding portion of the bundle of sheets from the back and inserts the same into the nipping portion N of the pair of center-folding rollers 43. The bundle of sheets pushed into the nipping portion N is nipped and conveyed by the pair of center-folding rollers 43 and folded into two-fold. The bundle of sheets which is center-folded is conveyed along the sheet-discharging guide 46 (refer to FIG. 3) by the pair of center-folding rollers 43 and, then discharged to the sheet-discharging tray 47.

Here, in the present embodiment, the first clearance W1 is set to have a small value, and the second clearance W2 is set to have a value greater than the first clearance W1, as described above. Therefore, the leading end of the center-folding blade 45 of the blade unit 44 can be swung about the first guide rollers 61, 61 a distance corresponding to the second clearance W2.

When the number of sheets P is small, and the thickness of the bundle of sheets is small, the blade unit 44 pushes up the folding portion or the stapling portion of the bundle of sheets at the leading end 45a of the center-folding blade 45, and inserts the same into the nipping portion N between the pair of center-folding rollers 43 while maintaining the above-described reference posture.

By the way, when the thickness of the bundle of sheets is greater as the number of sheets to be folded increase, the gap of the nipping portion N become wider owing to that the separated distance between the first roller 41 and second roller 42 increases as the thickness of the bundle of sheets is greater. This gap, in principle, can be twice as large as the thickness of the bundle of sheets. In this case, the leading end of the center-folding blade 45 is moved by the bundle of sheets toward a center of the nipping portion N, in other words, from the surface of the first roller 41 toward the second roller 42 an amount corresponding to the thickness of the bundle of sheets.

At this time, since the blade unit 44 can move a distance corresponding to the second clearance W2 as described above, the blade unit 44 as a whole follows in accordance with the movement of the center-folding blade 45, thereby pushing the bundle of sheets into the nipping portion N in a stable posture. In other words, the second clearance is secured to allow the center-folding blade 45 to move freely without any difficulty in accordance with a thickness of the bundle of sheets to be center-folded. It means that each of the second guide rollers 62, 62 has a diameter which allows the center-folding blade 45 to move. Therefore, in a case where the thickness of the bundle of sheets is small, and even in the case where the thickness is large, deviation of position, wrinkles, breakage of the bundle of sheets can be prevented from occurring.

If the above-described second clearance W2 is unnecessarily large, the posture of the blade unit 44 is likely to be unstable. Therefore, it is preferable to set the second clearance W2 such that a swing width F of the leading end 45a of the center-folding blade 45 becomes smaller than the maximum thickness of the bundle of sheets which are to be center-folded.

Further, as shown in FIG. 7, when a ratio of a distance L1 from the leading end 45a of the center-folding blade 45 to the first guide roller 61 to a distance L2 from the center of the first guide roller 61 to the center of the second guide roller 62 is L2/L1, the second clearance W2 is set to be smaller as the distance ratio becomes smaller. In other words, as a method for calculating the second clearance W2, a swing width F of the leading end 45a of the center-folding blade 45 is set to be smaller than a maximum thickness of the bundle of sheets to be folded into two-fold. Next, based on a relationship between the distances L1, L2, the second clearance W2 is determined such that the swing width F of the leading end 45a of the center-folding blade 45 becomes smaller than the thickness of the bundle of sheets.

In the above descriptions, the present invention is described with the example where a bundle of sheets is folded at its center after being formed with image. However, the present invention may be widely applied to a case where a bundle of sheets is folded regardless of image forming, or a case where a bundle of sheet is folded into two-fold at not a center but a desirable position.

The specific embodiment described above mainly includes the following arrangements.

A sheet folding apparatus comprises: a pair of center-folding rollers including a first roller and a second roller, each roller being rotatable about an axis thereof, the first roller and the second roller being made pressed contact with each other to define a nipping portion but being separable from each other; a center-folding blade projecting toward the nipping portion for pushing a folding portion of the bundle of sheets into the nipping portion so as to allow the pair of center-folding rollers to nip and convey the folding portion to thereby fold the bundle of sheets into two-fold; a holder for holding a base end portion of the center-folding blade; a guide member including a guide groove having a pair of guide surfaces extending along a tangential direction through the nipping portion; a first guide roller and a second guide roller held by the holder and rollable in the guide groove, the first guide roller being arranged closer to the nipping portion than the second guide roller; and a driving mechanism for moving the center-folding blade to the nipping portion via the holder, wherein a first clearance between a groove width of the guide groove and a diameter of the first guide roller is a first necessity minimum length to allow the first guide roller to roll in the guide groove, and a second clearance between the groove width and a diameter of the second guide roller is a second length longer than the first necessity minimum length.

According to this arrangement, the holder is movable within a range between a position where the second guide roller comes in contact with one guide surface and a position where the second guide roller comes in contact with other guide surface, with the first guide roller as a center. At which position the holder comes into a stable posture between any one of the positions within the range is unambiguously determined in accordance with a moment applied to the center of the first guide roller. The amount of the moment is changed during the folding operation, but its direction is not changed. Thus, when the bundle of sheets has a small thickness, or when it has a great thickness, a posture of the holder and center-folding blade is not greatly changed during the folding operation. Accordingly, deviation of a folding position, wrinkles, breakage and the like which are likely to be generated when the bundle of sheets is thick can be suppressed.

In this case, it is preferable that the first roller is given with a driving force, and the second roller which comes in pressed contact with the first roller to define the nipping portion is rotated by the first roller. The second roller is movable in a direction of separating from the first roller.

In the above-described arrangement, it is preferable that the guide surface positioned on the side of the driven center-folding roller serves as a reference guide surface, and when the second guide roller comes in contact with the reference guide surface, the holder and the center-folding blade are in a reference posture in which a leading end of the center-folding blade directs to the nipping portion.

According to this arrangement, the second guide roller comes in contact with the reference guide surface in the reference posture of the holder and center-folding blade. Accordingly, a second clearance is secured between the second guide roller and the other guide surface. Therefore, when the bundle of sheets has a great thickness, and the folding portion of the bundle of sheets is pushed into the nipping portion by the center-folding blade, the driven center-folding roller is separated from the driving center-folding roller. Further, the center-folding blade is also moved toward the driven center-folding roller an amount corresponding to the thickness of the bundle of sheets. Accordingly, the second guide roller is moved toward the other guide surface about the first guide roller as a center. In other words, the second guide roller is moved in a direction of making the second clearance be narrow. The amount of movement of the second roller becomes greater as the thickness of the bundle of sheets becomes greater, and the second clearance becomes that amount narrower. In other words, the second clearance allows the center-folding blade to follow with respect to a thickness of the bundle of sheets.

In the above-described arrangement, it is preferable that the holder and the center-folding blade come into the reference posture under their own weight. According to this arrangement, the holder and center-folding blade can be easily moved by following a force given thereto.

Further, it is preferable that a biasing member for biasing the holder and the center-folding blade to the reference posture is provided. According to this arrangement, the biasing member urges the holder and the center-folding blade to stably maintain the reference posture of the same.

In the above-described arrangement, it is preferable that the holder includes a shaft for rotatably supporting the first guide roller, and the driving mechanism transmits a driving force to the holder via the shaft. According to this arrangement, the action of the center-folding blade and the holder is freely made. In other words, a transmission of a driving force does not interfere with the action of the center-folding blade and the holder.

In this case, it is preferable that the driving mechanism transmits a driving force to the shaft via a crank mechanism. According to this arrangement, a favorable movement can be given to the center folding blade which presses the bundle of sheets into the nipping portion.

In the above-described arrangement, it is preferable that the second clearance is smaller as a ratio of a distance between a center of the first guide roller and a center of the second guide roller against a distance between a leading end of the center-folding blade and a center of the first guide roller becomes smaller.

According to this arrangement, the second clearance and a swing width of a leading end of the center-folding blade are made substantially proportional. Thus, the second clearance is made small when the distance ratio is small, thereby preventing the swing width of the center-folding blade from becoming greater than the necessity minimum.

In this case, it is preferable that the second clearance is set such that a swing width of the center-folding blade is smaller than the thickness of the bundle of sheets to be folded.

According to this arrangement, the defect can be prevented which occurs when a swing width of the center-folding blade is greater than the thickness of the bundle of sheets. Specifically, the defect can be prevented which a posture of the center-folding blade and the holder becomes stable when the second guide roller does not come in contact with the other guide surface.

A sheet folding apparatus comprises: a pair of center-folding rollers including a first roller and a second roller, each roller being rotatable about an axis thereof, the first roller and the second roller being made pressed contact with each other to define a nipping portion but being separable from each other; a center-folding blade projecting toward the nipping portion for pushing a folding portion of the bundle of sheets into the nipping portion so as to allow the pair of center-folding rollers to nip and convey the folding portion to thereby fold the bundle of sheets into two-fold; a holder for holding a base end portion of the center-folding blade; a guide member including a guide groove having a pair of guide surfaces extending along a tangential direction of the nipping portion; a first guide roller and a second guide roller held by the holder and rollable in the guide groove, the first guide roller being arranged closer to the nipping portion than the second guide roller; and a driving mechanism for moving the center-folding blade to the nipping portion via the holder. The center-folding blade is movable about the first guide roller supported at the guide surface in accordance with a thickness of a bundle of sheets to be folded at its center, and the second guide roller has a roller diameter operable to allow the movement of the center-folding blade.

A sheet processing apparatus comprises: a sheet folding apparatus for performing a center-folding processing to a bundle of sheets; a sheet-receiving portion for receiving supply of the sheet; a sheet-discharging portion for discharging a processed sheet; and a conveyance path for allowing the sheet supplied from the sheet-receiving portion to be conveyed to the sheet-discharging portion via the sheet folding apparatus. The sheet folding apparatus includes: a pair of center-folding rollers including a first roller and a second roller, each roller being rotatable about an axis thereof, the first roller and the second roller being made pressed contact with each other to define a nipping portion but being separable from each other; a center-folding blade projecting toward the nipping portion for pushing a folding portion of the bundle of sheets into the nipping portion so as to allow the pair of center-folding rollers to nip and convey the folding portion to thereby fold the bundle of sheets into two-fold; and a pivotal shaft for swingably supporting the center-folding blade so as to allow a projecting leading end of the center-folding blade to be swung in accordance with a thickness of a bundle of sheets to be folded at its center.

This application is based on Japanese Patent application serial no. 2006-180966 filed in Japan Patent Office on Jun. 30, 2006, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A sheet folding apparatus for folding a bundle of sheets at its center, the sheet folding apparatus comprising:
a pair of center-folding rollers including a first roller and a second roller, each roller being rotatable about an axis thereof, the first roller and the second roller being made pressed contact with each other to define a nipping portion but being separable from each other;
a center-folding blade projecting toward the nipping portion for pushing a folding portion of the bundle of sheets into the nipping portion so as to allow the pair of center-folding rollers to nip and convey the folding portion to thereby fold the bundle of sheets into two-fold;
a holder for holding a base end portion of the center-folding blade;
a guide member including a guide groove having a pair of guide surfaces extending along a tangential direction through the nipping portion;
a first guide roller and a second guide roller held by the holder and rollable in the guide groove, the first guide roller being arranged closer to the nipping portion than the second guide roller; and
a driving mechanism for moving the center-folding blade to the nipping portion via the holder,
wherein a first clearance between a groove width of the guide groove and a diameter of the first guide roller is a first necessity minimum length to allow the first guide roller to roll in the guide groove, and a second clearance between the groove width and a diameter of the second guide roller is a second length longer than the first necessity minimum length.

2. The sheet folding apparatus according to claim 1, wherein the first roller is given with a driving force; and
the second roller which comes in pressed contact with the first roller to define the nipping portion is rotated by the first roller, the second roller being movable in a direction of separating from the first roller.

3. The sheet folding apparatus according to claim 2, wherein the guide surface positioned on the side of the driven center-folding roller serves as a reference guide surface, and when the second guide roller comes in contact with the reference guide surface, the holder and the center-folding blade are in a reference posture in which a leading end of the center-folding blade directs to the nipping portion.

4. The sheet folding apparatus according to claim 3, wherein the holder and the center-folding blade come into the reference posture under their own weight.

5. The sheet folding apparatus according to claim 3, further comprising:
a biasing member for biasing the holder and the center-folding blade to the reference posture.

6. The sheet folding apparatus according to claim 1, wherein the holder includes a shaft for rotatably supporting the first guide roller, and the driving mechanism transmits a driving force to the holder via the shaft.

7. The sheet folding apparatus according to claim 6, wherein the driving mechanism transmits a driving force to the shaft via a crank mechanism.

8. The sheet folding apparatus according to claim 1, wherein the second clearance is smaller as a ratio of a distance between a center of the first guide roller and a center of the second guide roller against a distance between a leading end of the center-folding blade and a center of the first guide roller becomes smaller.

9. The sheet folding apparatus according to claim 8, wherein the second clearance is set such that a swing width of the center-folding blade is smaller than the thickness of the bundle of sheets to be folded.

10. A sheet folding apparatus for folding a bundle of sheets at its center, the sheet folding apparatus comprising:
a pair of center-folding rollers including a first roller and a second roller, each roller being rotatable about an axis thereof, the first roller and the second roller being made pressed contact with each other to define a nipping portion but being separable from each other;
a center-folding blade projecting toward the nipping portion for pushing a folding portion of the bundle of sheets into the nipping portion so as to allow the pair of center-folding rollers to nip and convey the folding portion to thereby fold the bundle of sheets into two-fold;
a holder for holding a base end portion of the center-folding blade;
a guide member including a guide groove having a pair of guide surfaces extending along a tangential direction of the nipping portion;
a first guide roller and a second guide roller held by the holder and rollable in the guide groove, the first guide roller being arranged closer to the nipping portion than the second guide roller; and
a driving mechanism for moving the center-folding blade to the nipping portion via the holder,
wherein the center-folding blade is swingable about the first guide roller supported at the guide surface in accordance with a thickness of a bundle of sheets to be folded at its center, and
the second guide roller has a roller diameter operable to allow the movement of the center-folding blade.

11. A sheet processing apparatus for performing a predetermined processing to a sheet, the sheet processing apparatus comprising:
a sheet folding apparatus for performing a center-folding processing to a bundle of sheets;
a sheet-receiving portion for receiving supply of the sheet;
a sheet-discharging portion for discharging a processed sheet; and
a conveyance path for allowing the sheet supplied from the sheet-receiving portion to be conveyed to the sheet-discharging portion via the sheet folding apparatus,
wherein the sheet folding apparatus includes:
a pair of center-folding rollers including a first roller and a second roller, each roller being rotatable about an axis thereof, the first roller and the second roller being made pressed contact with each other to define a nipping portion but being separable from each other;
a center-folding blade projecting toward the nipping portion for pushing a folding portion of the bundle of sheets into the nipping portion so as to allow the pair of center-folding rollers to nip and convey the folding portion to thereby fold the bundle of sheets into two-fold; and
a pivotal shaft for swingably supporting the center-folding blade so as to allow a projecting leading end of the center-folding blade to be swung in accordance with a thickness of a bundle of sheets to be folded at its center.

12. The sheet processing apparatus according to claim 11, further comprising:
a holder for holding a base end portion of the center-folding blade;
a guide member including a guide groove having a pair of guide surfaces extending along a tangential direction through the nipping portion;
a first guide roller and a second guide roller held by the holder and rollable in the guide groove, the first guide roller being arranged closer to the nipping portion than the second guide roller; and
a driving mechanism for moving the center-folding blade to the nipping portion via the holder,
wherein the first guide roller functions as the pivotal shaft, and the second guide roller has a roller diameter operable to allow the movement of the center-folding blade.

13. The sheet processing apparatus according to claim 12, wherein a first clearance between a groove width of the guide groove and a diameter of the first guide roller is a first necessity minimum length to allow the first guide roller to roll in the guide groove, and a second clearance between the groove width and a diameter of the second guide roller is a second length longer than the first necessity minimum length.

14. The sheet processing apparatus according to claim 12, wherein the first roller is given with a driving force; and
the second roller which comes in pressed-contact with the first roller to define the nipping portion is rotated by the first roller, the second roller being movable in a direction of separating from the first roller.

15. The sheet processing apparatus according to claim 14, wherein the guide surface positioned on the side of the driven center-folding roller serves as a reference guide surface, and when the second guide roller comes in contact with the reference guide surface, the holder and the center-folding blade are in a reference posture in which, a leading end of the center-folding roller directs to the nipping portion.

16. The sheet processing apparatus according to claim 15, wherein the holder and the center-folding blade come into the reference posture under their own weight.

17. The sheet processing apparatus according to claim 15, further comprising:
a biasing member for biasing the holder and the center-folding blade to the reference posture.

18. The sheet processing apparatus according to claim 12, wherein the holder includes a shaft for rotatably supporting the first guide roller, and the driving mechanism transmits a driving force to the holder via the shaft.

19. The sheet processing apparatus according to claim 11, further comprising:
a stapling apparatus for performing a stapling processing of hitting a staple to the bundle of sheets.

20. The sheet processing apparatus according to claim 19, wherein
the stapling apparatus performs a center-binding at the substantially central portion of a bundle of sheets before the bundle of sheets are folded in the sheet folding apparatus, and
the sheet folding apparatus folds the bundle of sheets at the folding portion to which the center-binding is performed.
